(19) United States
(12) Patent Application Publication
(10) Pub. No.: US 2022/0410450 A1
(43) Pub. Date: Dec. 29, 2022

(54) Method for Producing a Holding Device

(71) Applicant: ZKW Group GmbH, Wieselburg (AT)

(72) Inventors: Johann Steinkellner, St. Oswald (AT); Alexander Hacker, Wilhelmsburg (AT); Peter Schadenhofer, Roggendorf (AT)

(21) Appl. No.: 17/775,104

(22) PCT Filed: Nov. 19, 2020
(86) PCT No.: PCT/EP2020/082666

§ 371 Date: May 6, 2022

(30) Foreign Application Priority Data
Dec. 18, 2019 (EP) 19217621.2

(51) Int. Cl. B29C 45/14; B29C 45/26; G02B 7/02; F21S 41/20; F21S 41/32; B29D 11/00

(52) U.S. Cl. CPC B29C 45/14262; B29C 45/26; B29C 45/14065; G02B 7/021; F21S 41/285; F21S 41/322; B29D 11/00692; B29L 2011/0075

(57) ABSTRACT

1. A method for producing a holding device (1), wherein a light guide channel (2) is formed in the holding device (1) and extends from a first end section (2a) to a second end section (2b) of the holding device (1), wherein the first end section (2a) has a receiving region, in which a first optical element (3) can be fastened in a form-fitting manner, wherein the second end section (2b) has a stop surface (5) for the connection to a second optical element (4), and wherein the method comprises the following steps:

a) providing the first optical element (3),

b) providing an injection molding device for carrying out an injection molding process, wherein the injection molding device has two mold halves,

c) introducing the first optical element (3) into the first mold half of the injection molding device,

d) closing the mold halves,

e) forming the first end section (2a) of the holding device,

f) forming a shell of the holding device (1), which encloses the light guide channel (2),

g) forming the second end section (2b), which terminates the shell of the holding device (1), together with the stop surface (5).

The invention pertains to a method for producing a holding device, wherein a light guide channel is formed in the holding device, wherein said light guide channel extends from a first end section to a second end section of the holding device and ends in a light emitting region, wherein the first end section has a receiving region, in which a first optical element can be fastened in a form-fitting manner, wherein the first optical element has a first optical axis, wherein the second end section has a stop surface for the connection to a second optical element, wherein the second optical element has a second optical axis, and wherein the stop surface encloses and delimits the light emitting region.

The invention furthermore pertains to a holding device.

Holding devices that are designed in the form of a light guide channel and serve for holding optical components are known from the prior art.

The first and second end sections of known holding devices have disadvantageous structural inaccuracies that are caused by the production process. If optical components are fastened on the end sections of the holding device, flaws or inaccuracies therefore can occur in the transmission of light from a first to a second optical component.

The objective of the present invention can be seen in reducing or eliminating the disadvantages of the prior art. The invention particularly aims to develop a method for producing an improved holding device.

This objective is attained by means of a method with the characteristics of claim 1. Preferred embodiments are disclosed in the dependent claims.

According to the invention, the method comprises the following steps:

a) providing the first optical element;

b) providing an injection molding device for carrying out an injection molding process, wherein the injection molding device has a first and a second mold half, which in the closed state jointly enclose a cavity for forming the holding device, wherein a first part of the cavity is formed in the first mold half and a remaining second part of the cavity is formed in the second mold half, wherein the second part of the cavity in the second mold half is designed in the form of a depression, which extends from a dividing line of the two mold halves up to a first end face formed in the second mold half, wherein this first end face delimits the stop surface of a holding device to be formed in the cavity, wherein a die, which in the closed state extends in the direction of the first mold half, is arranged in the depression and defines the inner surface of a shell of the holding device enclosing this die in order to form the light guide channel of the holding device, wherein a second end face is formed by the end of the die facing the first mold half, and wherein the second end face of the die is formed parallel to the first end face formed in the second mold half,

c) introducing the first optical element into the first mold half of the injection molding device,

d) closing the mold halves, wherein the first optical element flatly abuts on the second end face such that its orientation is at least partially defined;

e) forming the first end section of the holding device by introducing injection molding material into the cavity and thereby overmolding the first optical element with injection molding material, wherein the first optical element abuts on the second end face in a form-fitting manner during the overmolding process,

f) introducing additional injection molding material for forming a shell of the holding device, which encloses the light guide channel, by overmolding the die with injection molding material,

g) forming the second end section, which terminates the shell of the holding device, together with the first stop surface by introducing additional injection molding material into the cavity.

The injection molding process preferably is an insert injection molding process. In steps d) and e), the first optical element abuts on the second end face, wherein the first optical axis of the first optical element preferably is oriented orthogonal to the second end face. The first and the second end face preferably are designed flat or plane or non-curved. The orientation of the first optical element therefore can be respectively defined or fixed in two dimensions due to the abutment of the first optical element on the second end face. The first optical element may have one degree of freedom when it abuts on the second end face, i.e. the first optical element may be rotatable about its optical axis, which preferably extends parallel, particularly coaxial, to the longitudinal axis of the die. A second optical element preferably is fastened on the second end section, wherein the second optical element may have an optically active surface that may be oriented orthogonal to its optical axis. When the second optical element is fastened on the second end section, the second optical element may contact the stop surface of the holding device, wherein the optically active surface may be oriented parallel to the stop surface and the second optical axis may be oriented orthogonal to the stop surface. A parallelism between the first and the second end face and/or an orthogonality of the first optical axis to the second end face and/or an orthogonality of the second optical axis to the first end face preferably is realized. When the first optical element is fastened on the first end section and the second optical element is fastened on the second end section, this provides the advantage that the first and the second optical axis are oriented parallel to one another, particularly in a coaxial manner. Consequently, light being emitted from the first optical element to the second optical element within the light guide channel can be guided from the first optical element to the second optical element in a particularly efficient manner. A very high accuracy with respect to the parallelism between the first and the second end face can be achieved because the first and the second end face are formed in the cavity of the second mold half and therefore in the same mold half, wherein a high accuracy in the parallelism between the first and the second end face results in a high accuracy in the parallelism between the facing optically active surfaces of the first and the second optical element. The high accuracy in the parallelism between the first and the second end face is also decisive for the parallelism between the first and the second optical axes. In this context, a high accuracy in the parallelism means that the deviation from a perfect parallelism is at a high accuracy as small as possible. Alternatively to the insert injection molding process, the injection molding device may also be designed for carrying out a 2K injection molding process. The introduction of the first optical element into the first mold half is not required in the case of a 2K injection molding process. A boundary surface of the first mold half, which extends up to the dividing line of the two mold halves, may contact the second end face in the closed state of the two mold halves. The first end section of the holding device can be produced by introducing injection molding material into the cavity and thereby overmolding an end region of the die formed on the second end face with injection molding material. The first optical element preferably can be fastened on the first end section in a form-fitting manner.

The longitudinal axis of the die may be oriented normal to the first and the second end face and the optical axis of the first optical element may in step d) be oriented parallel to the longitudinal axis of the die. The second optical axis of the second optical element preferably is oriented parallel to the longitudinal axis of the die.

The holding device may be designed in such a way that the optical axis of the first optical element and the optical axis of the second optical element extent parallel to one another, preferably in a coaxial manner, when the first optical element is fastened on the first end section and the second optical element is fastened on the stop surface of the second end section.

Light may propagate within the light guide channel from the first optical element to the second optical element parallel to the optical axis of the first and the second optical element. This provides the advantage that the light transmission from the first optical element to the second optical element can take place in an efficient and lossless manner. After passing through the second optical element, the light furthermore can be respectively emitted from or exit a light emitting surface of the second optical element in a particularly uniform manner. In this context, uniform means that light is emitted from the light emitting surface of the second optical element with a constant brightness per light emitting surface unit.

The first optical element may be a collimator. The collimator preferably is designed for receiving light from a light source, collimating the light beams and emitting the light beams in the form of a parallel pencil of rays. The collimator may have a light emitting region, from which the collimated light of the light source is emitted. The light emitting region of the collimator may comprise an emitting surface, from which light can be respectively emitted or exit and which preferably abuts on the second end face during step e). The emitting surface of the collimator preferably extends parallel to the second end face and orthogonal to the first and/or second optical axis.

The second optical element may be a microlens array. The microlens array (MLA) may have an optically active surface that faces the emitting surface of the second [sic] optical element or the collimator, respectively. Light can be emitted from the first optical element to the optically active surface of the MLA through the light guide channel of the holding device. The MLA may have a light emitting surface on the side facing away from the first optical element, wherein said light emitting surface is formed by a plurality of lenses, particularly microlenses, which are arranged on the light emitting surface in the form of a matrix (or grid). Each microlens of the MLA may be designed for emitting light in the form of a pencil of rays. The use of an MLA provides the advantage that a potential burning glass effect can occur within the MLA and not within the holding device. The holding device therefore can be produced of a softer material. Consequently, the holding device can be produced of multiple components such that the holding device can be provided, for example, with inspection windows.

The holding device and the first and second optical elements fastened thereon may form a closed volume.

According to the invention, a holding device is provided, wherein the holding device is produced with the inventive method. The holding device comprises a light guide channel that extends from a first end section to a second end section of the holding device and ends in a light emitting region, wherein a first optical element may be fastened on the first end section and a second optical element may be fastened on the second end section, and wherein the first optical element has a first optical axis and the second optical element has a second optical axis. When the first optical element is fastened on the first end section and the second optical element is fastened on the second end section, the first optical axis preferably is oriented parallel, particularly coaxial, to the second optical axis.

In the context of this description, the terms “top,” “bottom,” “horizontal” and “vertical” refer to the orientation, in which the method is carried out with an injection molding device in its normal operating position.

The invention is described in greater detail below with reference to a preferred exemplary embodiment, but it should be noted that the invention is not limited to this exemplary embodiment. In the drawings:

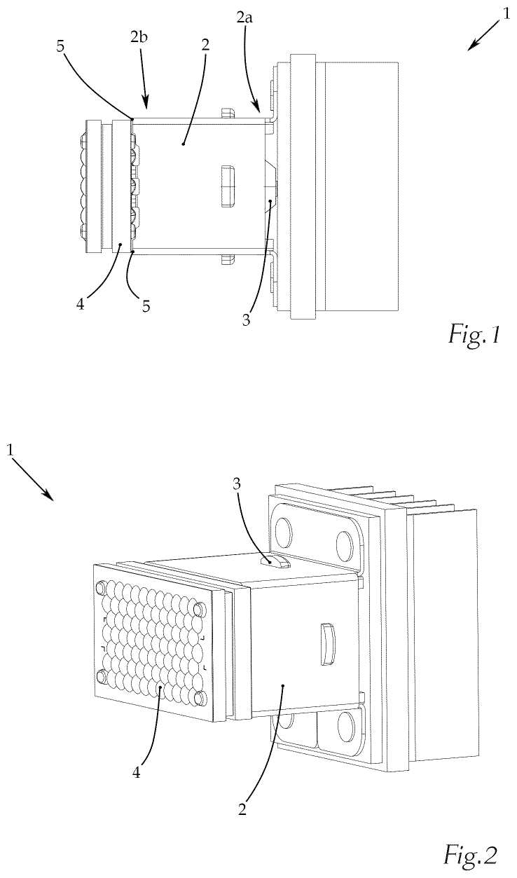

FIG. 1 shows a side view of an inventive holding device with a first and a second optical element;

FIG. 2 shows a perspective view of the holding device according to FIG. 1; and

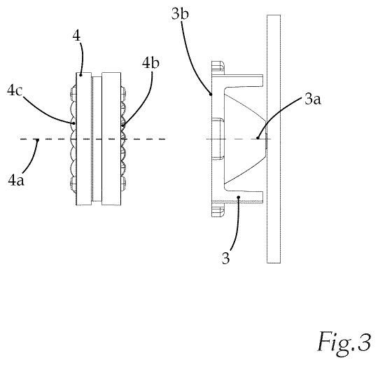

FIG. 3 shows a first and a second optical element without the holding device.

FIG. 1 and FIG. 2 show views of a holding device 1, wherein a light guide channel 2 is formed in the holding device 1, and wherein said light guide channel extends from a first end section 2a to a second end section 2b of the holding device 1 and ends in a light emitting region. A first optical element 3 with a first optical axis 3a (see FIG. 3) is fastened on the first end section 2a. The first optical element 3 is a collimator in the exemplary embodiment shown. A second optical element 4 with a second optical axis 4a is fastened on the second end section 2b. The second optical element 4 is a microlens array in the exemplary embodiment shown. The first end section 2a has a receiving region, in which the first optical element 3 is fastened in a form-fitting manner. The second end section 2b has a stop surface 5, on which the second optical element 4 is fastened. FIGS. 1 and 2 show that a heat sink may be fastened on the first optical element.

Due to the inventive method, the first end section 2a and the second end section 2b are designed in such a way that the first optical axis 3a and the second optical axis 4a extend parallel, preferably coaxial, to one another when the first optical element 3 is fastened on the first end section 2a and the second optical element 4 is fastened on the second end section 2b.

According to FIG. 3 (in which the holding device is not illustrated in order to provide a better overview), the first optical element 3 has the first optical axis 3a and an optically active surface 3b extending orthogonal to the first optical axis, wherein light, preferably collimated light, can be emitted from said optically active surface. The light is emitted in the direction of the second optical element 4 and is incident on a second optically active surface 4b of the second optical element 4. The light passes through the second optical element 4 and is emitted on a light emitting surface 4c. In order to allow an efficient and preferably lossless light transfer from the first optical element 3 to the second optical element 4, as well as a preferably uniform light emission from the light emitting surface 4c of the second optical element 4, it is advantageous to orient the first optically active surface 3b and the second optically active surface 4b as parallel to one another as possible. In order to minimize the deviation of the parallelism, the injection mold, in which the holding device 1 is produced, is designed in such a way that a first and a second end face, on which the orientation of the first optical element 3 and the second optical element 4 is defined, are formed in the same mold half, namely in the second mold half in this example.

1. A method for producing a holding device (1), wherein a light guide channel (2) is formed in the holding device (1), wherein said light guide channel extends from a first end section (2a) to a second end section (2b) of the holding device (1) and ends in a light emitting region, wherein the first end section (2a) has a receiving region, in which a first optical element (3) can be fastened in a form-fitting manner, wherein the first optical element (3) has a first optical axis (3a), wherein the second end section (2b) has a stop surface (5) for the connection to a second optical element (4), wherein the second optical element (4) has a second optical axis (4a), wherein the stop surface (5) encloses and delimits the light emitting region, the method comprising:
a) providing the first optical element (3),
b) providing an injection molding device for carrying out an injection molding process, wherein the injection molding device has a first and a second mold half, which in the closed state jointly enclose a cavity for forming the holding device (1), wherein a first part of the cavity is formed in the first mold half and a remaining second part of the cavity is formed in the second mold half, wherein the second part of the cavity in the second mold half is designed in the form of a depression, which extends from a dividing line of the two mold halves up to a first end face formed in the second mold half, wherein this first end face delimits the stop surface of a holding device to be formed in the cavity, wherein a die, which in the closed state extends in the direction of the first mold half, is arranged in the depression and defines the inner surface of a shell of the holding device (1) enclosing this die in order to form the light guide channel (2) of the holding device (1), wherein a second end face is formed by the end of the die facing the first mold half, and wherein the second end face of the die is formed parallel to the first end face formed in the second mold half,
c) introducing the first optical element (3) into the first mold half of the injection molding device,
d) closing the mold halves, wherein the first optical element (3) flatly abuts on the second end face such that its orientation is at least partially defined,
e) forming the first end section (2a) of the holding device (1) by introducing injection molding material into the cavity and thereby overmolding the first optical element (3) with injection molding material, wherein the first optical element (3) abuts on the second end face in a form-fitting manner during the overmolding process,
f) introducing additional injection molding material for forming a shell of the holding device (1), which encloses the light guide channel (2), by overmolding the die with injection molding material, and
g) forming the second end section (2b), which terminates the shell of the holding device (1), together with the stop surface (5) by introducing additional injection molding material into the cavity.

2. The method according to claim 1, wherein the longitudinal axis of the die is oriented normal to the first and the second end face and the optical axis (3a) of the first optical element (3) is in step d) oriented parallel to the longitudinal axis of the die.

3. The method according to claim 1, wherein the holding device (1) is designed in such a way that the optical axis (3a) of the first optical element (3) and the second optical axis (4a) of the second optical element (4) extend parallel to one another when the first optical element (3) is fastened on the receiving region of the first end section (2a) and the second optical element (4) is fastened on the stop surface (5) of the second end section (2b).

4. The method according to claim 1, wherein light propagates within the light guide channel (2) from the first optical element (3) to the second optical element (4) parallel to the optical axes (3a, 4a) of the first (3) and the second optical element (4).

5. The method according to claim 1, wherein the first optical element (3) is a collimator.

6. The method according to claim 1, wherein the second optical element (4) is a microlens array.

7. The method according to claim 1, wherein the holding device (1) and the first (3) and second optical elements (4) fastened thereon form a closed volume.

8. A holding device (1) produced by the method of claim 1.
